(19) United States
(12) Patent Application Publication
(10) Pub. No.: US 2008/0255881 A1
(43) Pub. Date: Oct. 16, 2008

(54) Intelligent parallel processing system and method

(76) Inventor: George Bone, (US)

Correspondence Address: MAIER & MAIER, PLLC, 1000 DUKE STREET, ALEXANDRIA, VA, 22314, US

(21) Appl. No.: 11/806,146

(22) Filed: May 30, 2007

Related U.S. Application Data
(60) Provisional application No. 60/907,755, filed on Apr. 16, 2007.

(51) Int. Cl. G06Q 50/00; G06Q 10/00

(52) U.S. Cl. 705/3; 705/1; 705/2

(57) ABSTRACT

In at least one exemplary embodiment, a method and system for an automated intelligent parallel processing enabled architectural framework for supporting electronic human services (EHS) are disclosed. EHS include healthcare services. The system and method may include, for example, a methodology and process environment component having an intelligent parallel business process, a collaborative environment component, and a knowledge enablement and augmentation environment component that are operatively interconnected via an intelligent broker component/module. The architectural framework can be applied to one or more domains on a network. The intelligent parallel business process can include an initiation sub-process, an evaluation sub-process, a formulation sub-process and a communication sub-process.

### CROSS REFERENCE TO RELATED APPLICATIONS

This application claims priority, under 35 U.S.C. §119(e), to U.S. Provisional Patent Application Ser. No. 60/907,755, filed Apr. 16, 2007, the disclosure of which is incorporated by reference herein in its entirety.

### FIELD

The present invention is related in general to architectural frameworks and, more particularly, to the use of effectively linked architectural frameworks supporting electronic human services.

### BACKGROUND

The electronic human services (EHSs) are the e-convenience services of healthcare, banking, finance, commerce, transportation, recreation, travel, entertainment industries and any other service that may be conveniently delivered electronically by any other industry. EHSs may be performed locally and/or globally via network enabled collaboration environments. Indeed, EHSs may very well benefit from network enabled collaboration environments that produce efficient, effective and automated enterprise EHSs and corresponding operations. A shortcoming of existing EHSs is their limited ability to capture domain-specific knowledge and act on this knowledge in an automated fashion.

Further, the EHS industries disclosed above—healthcare, banking, finance, commerce, transportation, recreation, travel and entertainment—are multi-trillion dollar industries. For example, the annual global expenditure for healthcare, according to some, exceeds three trillion dollars. This expenditure is approximately 8 percent of the world's gross domestic product (GDP). Healthcare spending in the United States alone is estimated by some to be over one trillion dollars; thus, it represents the largest sector of the U.S. economy. The enormous scale of these industries offers a huge potential for cost savings that is not fully realized by existing EHS systems.

Commercial Off-The-Shelf (COTS) software components such as databases, user interface frameworks and configuration management software packages provide many of the building blocks necessary to create an improved EHS system. However, several additional concepts are necessary to effectively capture the domain-specific knowledge and potential cost savings lacking in existing EHS systems.

The administration of healthcare has yet to fully benefit from technology and remains highly inefficient. One of the manifestations of this inefficiency is that one in six Americans go without health care coverage despite healthcare being in excess of a trillion dollar industry in the United States. The pressing need to improve the efficiency of healthcare delivery is being driven by the aging of the US population; 20% of whom will be over 65 years old by 2025. The access to care will be further compounded by the retirement of 425,000 physicians by the year 2020, at the same time that there is projected to be a doubling of the demand for medical care due to the growth in the aging population.

### SUMMARY

In accordance with at least one embodiment, an architectural framework on a network having one or more domains is disclosed. The architectural framework can include a collaborative environment component, a methodology and process environment component, and a knowledge enablement and augmentation environment component that can be operatively interconnecting by an intelligent broker. Moreover, the methodology and process environment can have a business process embodied in a computer readable media where the business process is applied to one or more domains.

In yet another embodiment, a method of modeling a use case by applying a spiral methodology to one or more domains on a network is disclosed. The method can include having the one or more domains accessible to client computational devices. Also, a business process can be embodied on a computer readable media and stored on the network where the business process is configured to apply a spiral methodology to the one or more domains. The business process can include the steps of: initiating concept capturing for a use case by querying an actor operating a client computational device; evaluating data submitted by the actor in response to one or more queries; establishing a baseline plan based on the evaluated data; formulating a solution for the use case in accordance with the baseline plan; generating data associated with the solution for the use case; communicating the data to one or more client computational devices, and closing out the use case.

### BRIEF DESCRIPTION OF THE FIGURES

Advantages of embodiments of the present invention will be apparent from the following detailed description of the exemplary embodiments thereof, which description should be considered in conjunction with the accompanying drawings, in which like numerals indicate like elements, in which:

FIG. 1 is a diagram showing an exemplary computer system.

FIG. 2 is a diagram showing environmental components interconnecting by an intelligent broker component of an exemplary architectural framework applied to one or more domains.

FIG. 3 is another diagram showing an exemplary architectural framework applied to one or more domains.

FIG. 4 is a diagram showing an enterprise architectural framework in accordance with at least one embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that, upon execution, would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

To facilitate an understanding of the description discussion of several terms used herein follows.

The “Automated Intelligent Parallel Process Solution (AIPPS)” is an architectural framework comprising four key differentiating integrated building blocks. These building blocks are the Collaborative Environment (CE), Methodology and Process Environment (MPE), Intelligent Broker (IB) environment, and Knowledge Enablement and Augmentation (KEA) Environment. Each of these building blocks is based on viable/proven methodology and technology that exist today.

“Change Management” refers to a process/component that: manages each request for change, in a manner that provides full traceability; ensures that each request for change is assessed by key stakeholders; ensures that each assessed change request is accepted, rejected, or deferred by the appropriate authority; enables the orderly implementation of each accepted change; and allows the impact of all changes to be understood, documented and managed. The primary focus of change management is on those changes that are introduced by problem domain specialists, such as changes to requirements or the content of deliverables.

The “Collaboration module” is the component that provides a Graphical User Interface (GUI) and the logic necessary for multiple users to interact. It is the collection of components/software that implements the Collaborative Environment (CE).

The “Collaborative Environment (CE)” of the exemplary embodiment allows two or more participants to communicate, coordinate and collaborate to accomplish a shared task or objective, and to reach a decision(s). In addition, the exemplary embodiment having a CE may provide users with web-enabled communication and collaboration abilities across multiple geographic sites and between various users spread across multiple internet domains, sites and time zones. The CE may be constructed from a range of computer and communication technologies, such as instant messaging, e-mail, electronic forums, chat rooms, discussion databases, mobile communicators, shared white boards, streaming media including audio, video or web conferences or any other collaborative technologies known to one having ordinary skill in the art.

“Configuration Management (CM)” system refers to a system that maintains a list of processes, tooling, resources for compliance with open standard guidelines, documents, or software versions and a cross-listed matrix that indicates the relationships between these items. CM should be substantially: (1) Controllable—all aspects of managed items are placed under configuration control to be readily identified and managed; (2) Reproducible—any previous version of the scenario artifacts and/or configurations (baselines) can be reproduced; and (3) Measurable—provide metrics for Use Case status and issues for use by operation management to make decisions and report on scenario performance.

“Configuration Management Plan” refers to the logical set of rules that govern how items that are under CM may be added, removed, modified, stored, activated, deactivated, combined and deployed to the actively operating architectural framework. Interface management control measures ensure that all internal and external interface requirement changes are properly documented in accordance with the Configuration Management Plan.

“Digital Media Solution (DMS)” or “Digital Media Subcomponent” refers to a component that stores, delivers, and provides access to digital content including but not limited to audio, video, images, data, and text.

“Electronic Convenience Services” are services that may be provided or facilitated through the intelligent application of data and rules that are defined for a specific problem domain. Problem domains include but are not limited to healthcare, banking, finance, commerce, transportation, recreation, travel, and entertainment industries.

“Enterprise Architectural Framework (EAF)” is the amalgamation of products, applications, services, and/or enabling infrastructure that encompasses an Electronic Human Services problem domain.

“Intelligent Messaging Broker” or “Intelligent Broker (IB)” handles requests or messages from one module or application to another. Multiple applications are able to simultaneously receive a particular message from any connected application that is publishing that message. An Intelligent Broker is able to perform any transformations that may be necessary in order to make the message decipherable to the target application.

“Intelligent Routing” describes the manner in which an Intelligent Broker can identify the type and target of a message from a particular source application and route it to the appropriate target application.

The “Knowledge Enablement and Augmentation (KEA)” environment refers to the set of software tools and data that relate to the specific problem domain. In an exemplary embodiment, the KEA environment comprises a Search Engine, a Knowledge Management solution and Digital Media Solution.

The “Knowledge Management (KM)” solution is a component/process for leveraging and utilizing the vast potential of both tacit knowledge and structured artifacts (tools, work products, code, solutions, techniques, templates, etc.) relevant to a problem domain.

“Methodology and Process Environment (MPE)” refers to the framework that enables specialists in the problem domain to define their requirements and capture the multiplicity of business processes that define that domain. A spiral development methodology is applied throughout the lifetime of this framework so that improvements can be made as knowledge of the problem domain grows. US Patent application 20050096937 “Method of automation of business processes and apparatus therefor,” herein incorporated by reference, teaches a method and apparatus for capturing business processes.

“Semantic modeling” refers to a modeling technique that is intelligent and dynamic-driven that when applied to a domain includes assembling, on-demand, the taxonomy and ontology of the domain to abstract and accommodate the modeling of relevant enterprise applications. Semantic modeling uses domain knowledge to make solutions more intelligent, adaptive and efficient while increasing functionality and optimizing performance. The underpinnings of semantic modeling technique are described in M. Gelfond and V. Lifschitz, The stable model semantics for logic programming, In Proceedings of the Fifth Logic Programming Symposium, pp 1070-1080. The MIT Press, 1988, the contents of which are hereby incorporated by reference in their entirety into this patent application.

“Spiral development methodology” refers to a methodology for software design that comprises iterative phases of analysis, design, prototyping/implementation and testing. The iterative nature of this methodology enables the phases to be conducted in parallel with refinements to the phases at each cycle through the spiral.

“Unified Modeling Language (UML)” refers to the standardized language for modeling software objects that can be applied to a variety of fields including software design, business process design and system design. See Object Management Group, “Unified Modeling Language: Superstructure,” August 2005, the contents of which are hereby incorporated by reference in their entirety into this patent application.

“Web Browser Intelligence (WBI)” is the process of using intelligent agent technology to reduce the Internet's complexity, which may help users of all levels of experience. WBI can accomplish this, for example, by: noticing patterns in Web browsing and suggesting shortcuts; automatically checking favorite Web pages for changes; testing the speed of links between pages; remembering a complete Web history, thus, possibly making it easier to return to a site; searching through previously viewed information to find an information source, letting users look back in “Web time” to see how they have visited pages in the past; and providing connectivity to both Proxy and SOCKS servers. The WBI agent may be connected to a Web browser allowing it to capture information about each page a user may access. Over time, the agent may learn usage patterns well enough to predict users' patterns.

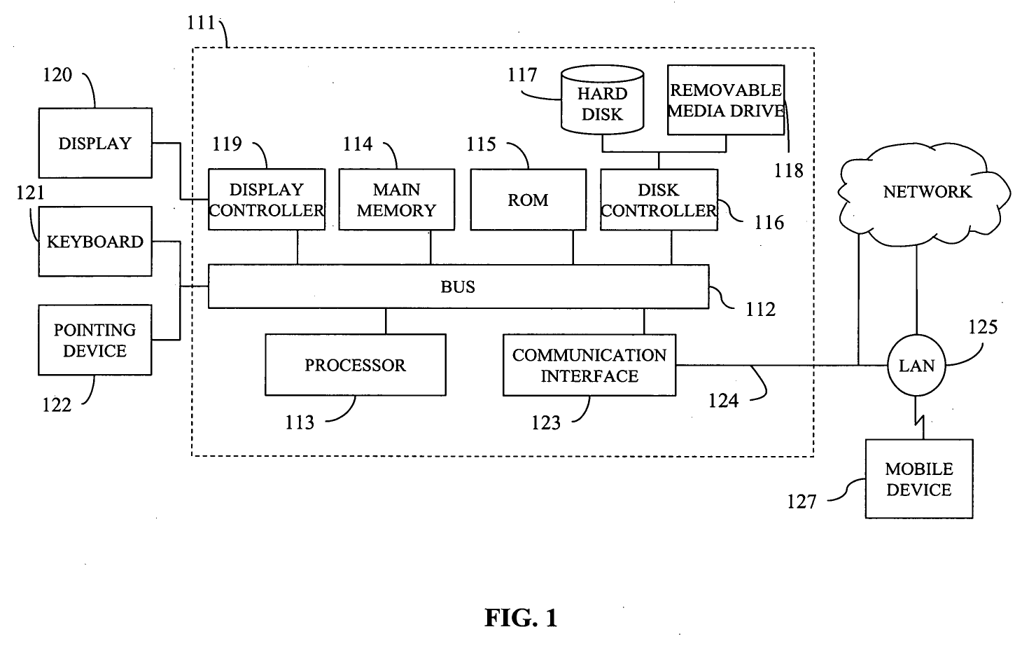

FIG. 1 illustrates a computer system (111) upon which an embodiment of the present invention may be implemented. The computer system (111) includes a bus (112) or other communication mechanism for communicating information, and a processor (113) coupled with the bus (112) for processing the information. The computer system (111) also includes a main memory (114), such as a random access memory (RAM) or other dynamic storage device (e.g., dynamic RAM (DRAM), static RAM (SRAM), and synchronous DRAM (SDRAM)), coupled to the bus (112) for storing information and instructions to be executed by processor (113). In addition, the main memory (114) may be used for storing temporary variables or other intermediate information during the execution of instructions by the processor (113). The computer system (111) further may include a read only memory (ROM) (115) or other static storage device (e.g., programmable ROM (PROM), erasable PROM (EPROM), and electrically erasable PROM (EEPROM)) coupled to the bus (112) for storing static information and instructions for the processor (113).

The computer system (111) also includes a disk controller (116) coupled to the bus (112) to control one or more storage devices for storing information and instructions, such as a magnetic hard disk (117), and a removable media drive (118) (e.g., floppy disk drive, read only compact disc drive, read/write compact disc drive, compact disc jukebox, tape drive, and removable magneto optical drive). The storage devices may be added to the computer system (111) using an appropriate device interface (e.g., small computer system interface (SCSI), Serial Advanced Technology Attachment (Serial ATA or SATA), Parallel ATA or PATA, integrated device electronics (IDE), enhanced-IDE (EIDE), direct memory access (DMA), or ultra DMA).

The computer system (111) may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system (111) may also include a display controller (119) coupled to the bus (112) to control a display (120), such as a cathode ray tube (CRT), liquid crystal display (LCD) or any other type of display, for displaying information to a computer user. The computer system includes input devices, such as a keyboard (121) and a pointing device (122), for interacting with a computer user and providing information to the processor (113). Additionally, a touch screen could be employed in conjunction with display (120). The pointing device (122), for example, may be a mouse, a trackball, or a pointing stick for communicating direction information and command selections to the processor (113) and for controlling cursor movement on the display (120). In addition, a printer may provide printed listings of data stored and/or generated by the computer system (111).

The computer system (111) performs a portion or all of the processing steps of the invention in response to the processor (113) executing one or more sequences of one or more instructions contained in a memory, such as the main memory (114). Such instructions may be read into the main memory (114) from another computer readable medium, such as a hard disk (117) or a removable media drive (118). One or more processors in a multi processing arrangement may also be employed to execute the sequences of instructions contained in main memory (114). In alternative embodiments, hard wired circuitry may be used in place of or in combination with software instructions. Thus, embodiments are not limited to any specific combination of hardware circuitry and software.

As stated above, the computer system (111) includes at least one computer readable medium or memory for holding instructions programmed according to the teachings of the invention and for containing data structures, tables, records, or other data described herein. Examples of computer readable media are compact discs, hard disks, floppy disks, tape, USB drives, magneto optical disks, PROMs (EPROM, EEPROM, flash EPROM), DRAM, SRAM, SDRAM, or any other magnetic medium, compact discs (e.g., CD ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system (111), for driving a device or devices for implementing the invention, and for enabling the computer system (111) to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor (113) for execution. A computer readable medium may take many forms, including but not limited to, non-volatile media, volatile media, and transmission media. Non volatile media includes, for example, optical, magnetic disks, and magneto optical disks, such as the hard disk (117) or the removable media drive (118). Volatile media includes dynamic memory, such as the main memory (114). Transmission media includes coaxial cables, copper wire and fiber optics, including the wires that make up the bus (112). Transmission media also may also take the form of spectra including but not limited to radio, light, infrared, and microwave frequencies.

Various forms of computer readable media may be involved in carrying out one or more sequences of one or more instructions to processor (113) for execution. For example, the instructions may initially be stored on a magnetic disk of a remote computer. The remote computer can load the instructions for implementing all or a portion of the present invention remotely into a dynamic memory and send the instructions over a network. The computer system (111) may receive the instructions across the network and execute them. The instructions received by the computer system (111) may optionally be stored on storage device (117) or (118) either before or after execution by processor (113).

The computer system (111) also includes a communication interface (123). The communication interface (123) provides a two way data communication coupling to a network link (124) that is connected to, for example, a local area network (LAN) (125), or to another communications network (126) such as the Internet. For example, the communication interface (123) may be a network interface card to attach to any packet switched LAN. As another example, the communication interface (123) may be an asymmetrical digital subscriber line (ADSL) card, an integrated services digital network (ISDN) card or a modem to provide a data communication connection to a corresponding type of communications line. Wireless links may also be implemented. In any such implementation, the communication interface (123) sends and receives electrical, electromagnetic or optical signals that carry various types of information.

The network link (124) typically provides data communication through one or more networks to other data devices. For example, the network link (124) may provide a connection to another computer or remotely located presentation device through a local network (125) (e.g., a LAN) or through equipment operated by a service provider, which provides communication services through a communications network (126). In preferred embodiments, the local network (124) and the communications network (126) preferably use electrical, (electromagnetic, or optical signals that carry digital data streams. The signals through the various networks and the signals on the network link (124) and through the communication interface (123), which carry the digital data to and from the computer system (111), are exemplary forms of carrier waves transporting the information. The computer system (111) can transmit and receive data, including program code, through the network(s) (125) and (126), the network link (124) and the communication interface (123). Moreover, the network link (124) may provide a connection through a LAN (125) to a mobile device (127) such as a personal digital assistant (PDA), laptop computer, or cellular telephone or any other mobile device known to one having ordinary skill in the art. The LAN communications network (125) and the communications network (126) both use electrical, electromagnetic or optical signals that carry digital data streams. The signals through the various networks and the signals on the network link (124) and through the communication interface (123), which carry the digital data to and from the system (111), are exemplary forms of carrier waves transporting the information. The processor system (111) can transmit notifications and receive data, including program code, through the network(s), the network link (124) and the communication interface (123).

This computer system may be implemented with any of the embodiments described herein. Alternatively, in other exemplary embodiments, the entire computer system may be replicated any number of times and used with any of the embodiments described herein. Additionally, any part of the computer system, for example the processor, may be replicated any number of times to implement any of the embodiments of the invention.

Other aspects of the invention may include data transmission and Internet-related activities. See Preston Graila, How the Internet Works, Ziff Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

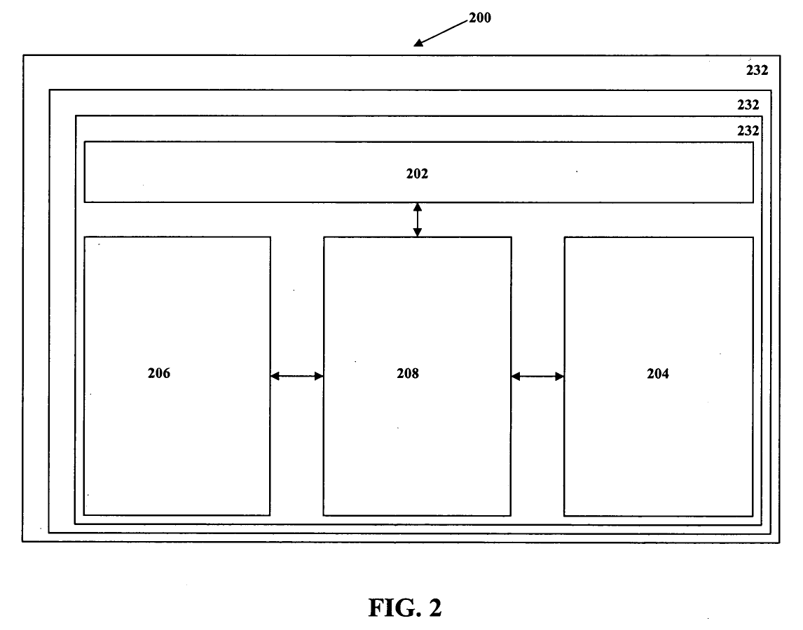

Referring to FIGS. 2-4, in one exemplary embodiment, an Automated Intelligent Parallel Processing Solution (AIPPS) enabled open Enterprise Architectural Framework (EAF) (200) may include a Collaborative Environment (CE) component (202), a Methodology and Process Environment (MPE) component (204) and a Knowledge Enablement and Augmentation (KEA) environment component (206) that are substantially operatively networked via an Intelligent Broker (IB) component/module (208). In a further exemplary embodiment, an enabled and integrated EAF (200) system and method may provide a single point of authentication and entry to multiple information sources and applications with a customizable user interface. It may provide a cluster of key functions to encapsulate specific support for the enabled and integrated EAF operations such as: capturing and managing requirements, Use Case modeling and tradeoff analysis, building templates, and generating and communicating reports.

At least one exemplary healthcare embodiment can be a web-based system and method that can have an online collaborate service environment where healthcare parties (such as patients, physicians, pharmacies, laboratories, research communities, insurance providers and business communities) can collaborate by, for example, creating, sharing and viewing healthcare-related data. At least one exemplary embodiment can potentially perform one or more functions including resolving active medical problems, enabling patients to increase their understanding and knowledge of their health conditions, recording and obtaining reports on patients' health status, communicating with their healthcare providers, ordering online prescription refills, viewing appointments and receiving reminders, and becoming better informed participants in improving their health by allowing them to take a proactive role in self-health assessment and management as well as shared healthcare decision making. For example, through at least one exemplary embodiment, healthcare professionals (e.g., doctors) may be able to order lab tests, medications, diets, radiology tests and procedures, record a patient's allergies or adverse reactions to medications, request and track consultations, register progress notes, enter diagnosis, enter treatments for each encounter, enter discharge summaries, provide patient's billing management solution to end users, and capture and store insurance data (including policy information and related benefits) as a few non-limiting examples.

Still referring to FIGS. 2-4, in exemplary healthcare embodiments, a user (such as a patient) can interact via the CE component (202) and may seek symptom complaint evaluation leading to a diagnosis, treatment appointment, laboratory tests, proposed procedure and/or general education. A exemplary healthcare embodiment including an MPE component (204) (having intelligent and adaptable parallel business process module that can comprise an initiation sub-process (210), an evaluation sub-process (212), a formulation sub-process (214) and a communication sub-process (216) can, in totality, form an ingest/export engine capability, which may store, record and export as data (e.g., image files, text files and/or multimedia files) inputs (e.g., by a patient) into Electronic Patient Record System (EPRS). The ingest/export engine capability can publish and subscribe, if and when demanded, to other components/modules where the IB module (208) can play the role of an electronic bridge.

For example, the IB module (208) can prompt a patient with preset queries that can be generated by the KM module (226) of the knowledge augmentation component (206) or with the aid of a physician. If the query were directed to another actor (such as a nurse) or domain (such as finance) server then the KM module (226) of that server may be activated. Each diagnostic scenario can be verified or nuanced by laboratory and imaging procedures quantified by a testing and integration unit (218) operatively linked to the information analysis segment of the evaluation sub-process (212), a specialty-specific diagnosis can be rendered by the formulation module (214). This specific diagnosis can then initiate a treatment scenario stored in the knowledge management module (226). Moreover, the completed symptom set/scenario, treatment protocol and response to treatment can be stored in a data repository unit.

If the knowledge augmentation module (206) cannot process the logic (i.e. make sense) of the scenario at hand, then it can either feedback to query the patient or trigger the doctor (MD) server for input to direct the questioning. The query can initiate the scenario, which can then initiate the sub-domain of the MD server to include other actors and associated workspace. Additionally, the query can request that the evaluation module (212) conduct further information capture, report template choice and issue a report. The evaluation module (212) can weight each of the diagnostic possibilities and select, as the leading diagnosis, the greatest weighted possibility in addition to ranking the others in a list. Once diagnostic scenario analysis is complete, the lab and imaging domains can be initiated via the IB module (208) on the formulation module (214). Output from these modules can be fed into the KM process (226) to be assessed for relevance before being forwarded to the use case actor's server to be stored in a data repository and available for later access. This information (data) can also be sent to the other actor's sub-domain data repository unit for further processing or storage. Each use case that may be solved can be the generator of other uses cases, thus, as applied to this example, then the next use case for the patient and family might be optimizing payment options, treatment side effect potentials, location of treatment, etc.

Each of these modules, components, sub-units, processes, sub-processes can work in a collaborative environment (202) publishing and subscribing to the meta-data search engine (224), the augmented knowledge module (206), the configuration management module (220) and the change management module (222). Moreover, processor modules and associated modules can be integrated in a feedback loop with the verification/validation testing and integration module (218) governed by domain/use case specific rules. All of these functionalities can run as independent parallel processes.

An AIPPS enabled and integrated EAF according to embodiments of the present invention can include multiple domains (232). For example, domains (232), which can be grouped and called patient domains (or patient care domains) (232), can include: primary care doctor domain; specialist care domain; community hospital domain; referral hospital domain; university hospital domain; nursing home domain; care coordination domain (for providing specified care at the specified location at the specified time); diagnostic services laboratory domain; diagnostic services imaging domain; health promotion and disease prevention (i.e. preventative care) domain; nursing professional domain(s); paraprofessional domain(s); pharmacy domain(s) (e.g., one for such items as prescriptions and another domain(s) for such items as durable medical equipment, prosthetics and sensory aids); rehabilitation domain; strategic planning and measurement domain (for such activities as policy analysis and forecasting, health systems analysis and application, clinical affairs and information management); dentistry domain; ethics domain (for such activities: as ethics policy development and analysis; and ethics evaluation, consultation and communications).

Additionally, other domains (232) can include family domain, business office domain (for such activities as insurance identification and verification, billing, accounts receivable, payer compliance, utilization review, health plan and program administration, human resources); research domain; quality and performance domain; and patient safety domain. Moreover, a finance domain can be incorporated for resource allocation (such as budget formulation, budget justification, budget execution, maintaining accounting systems, and financial management system monitoring) and also can include a support group for technical and analytic information services for finance. Further, a policy and planning domain can be incorporated for providing collaboration for advance system effectiveness including, for example, policy analysis and forecasting, strategic planning, health systems and health programs analysis and applications, and information. A policy and planning domain can also include systems support such as databases, and modeling and analysis applications for management support and policy development. Still other exemplary domains (232) that may be incorporated include a technical support domain (for information technology, informatics, network services, product analysis and development) and a compliance domain (for policies and procedures, education and training, auditing and monitoring, and enforcement and discipline).

At least one healthcare embodiment can treat, accommodate and perform all domains (232) included therein by applying the component environments of the architectural framework, which can be triggered and controlled by procedures (rules), entry criteria and exit criteria stored in the configuration management component (220). Thus, embodiments can navigate from one domain (232) to another (232) as required by the use case at hand.

Still referring to FIGS. 24, in one exemplary embodiment, an Automated Intelligent Parallel Processing Solution (AIPPS) system and method for integrating an Enterprise Architectural Framework (EAF) (200) having a Methodology and Process Environment (MPE) component (204) may have an intelligent and adaptable parallel business process module that may comprise an Initiation sub-process (210), an Evaluation sub-process (212), a Formulation sub-process (214) and a Communication sub-process (216).

An AIPPS enabled EAF system and method (200) according to the present exemplary embodiment having a Methodology and Process Environment (MPE) component (204) and further embodiments that may utilize the architectural framework system and method (200) as shown in FIGS. 24 to assist in enabling the realization of successful “end to end” Electronic Human Services (EHSs). The AIPPS system and method (200) of the present exemplary embodiment may also apply a continuous spiral development methodology that may effectively model the scenario entered by a user(s), capture its corresponding interactive template, and ultimately provide solutions which meets the users' needs. This methodology may reduce uncertainty and addresses solution risks earlier in the development lifecycle than traditional existing methods.

The AIPPS (200) of the present exemplary embodiment may deliver and demonstrate solution capability at each iteration of the spiral development cycle. Each spiral or solution build can have its own requirements, entrance criteria, functionality/capability, required modeling, risk mitigations, demonstration and test requirements, and exit criteria. Each spiral or solution may be able to further expand on the capability proven at the test phase of the previous spiral cycle. Common Unified Modeling Language (UML) techniques (including Use Case, Business Process, Class, Object Sequence, Collaboration, and State Transition Diagrams), and defined processes may be followed during the builds to capture additional functionality as well as other techniques and processes known to one having ordinary skill in the art. Developed solution capability may then be integrated and tested (218). Continuous testing (218) can occur throughout the spiral iteration. Indeed, in some exemplary embodiments, no solution integration may go without passing through incremental testing (218). This engineering development best practice may be performed in a coherent and integrated manner across the scenario's lifecycle to ensure early detection and removal of defects, ensure checks and balances, and reduce the overall realization cycle time and cost of the scenario.

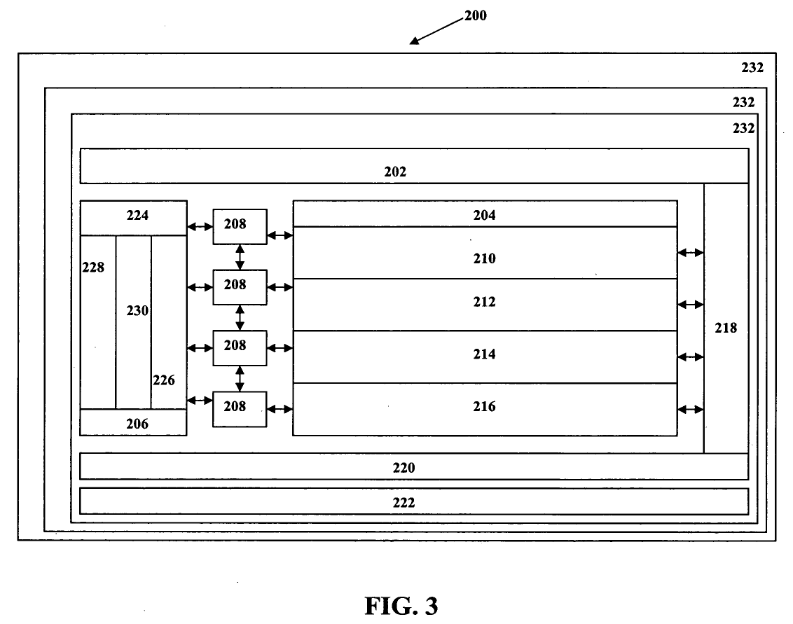

The above discussed spiral methodology of the AIPPS is an intelligent and adaptable parallel Business Process (see, for example, FIGS. 3 & 4) for establishing a requirements baseline to ensure completeness and reduce defects, providing traceability of customer requirements through acceptance criteria and verifying, through disciplined and traceable testing, that the customer requirements are successfully delivered according to acceptance criteria. Through this business process, the MPE (204) and associated methodology can focus on defining users' needs and may require functionality early in the scenario's lifecycle, documenting, validating, and verifying requirements and design while considering the complete solution effects, such as cost, time, performance, support, and testing. In further exemplary embodiments, the enabled and integrated EAF system and method (200) and components thereof may apply a suite(s) of tools, metrics, and multi-concurrent sub-processes (210, 212, 214 and 216) to create a baseline that drives toward a successful solution.

Moreover, in this or other embodiments, the Business Process may integrate and test four concurrent sub-processes that are described here as Initiation (210), Evaluation (212), Formulation (214), and Communication (216). These sub-processes can proceed from scenario concept capturing, to analysis, to design, and to communication where the goal of providing balanced decision realization may be sought. Thus, these sub-processes may lead to administrative cost and oversight reduction, business process optimization for maximizing effectiveness while ensuring efficiency, and accommodating change in mission from one domain (232) of operation to another.

An exemplary healthcare embodiment can apply the continuous spiral methodology to model the medical domain (232) at hand, capture its corresponding interactive template and to ultimately provide a solution which can be tailored to meet the patient's need. This methodology can reduce uncertainty and can address solution risks relatively early in the lifecycle. Moreover, it can deliver and demonstrate solution capability at each spiral-complete milestone. For example, each spiral (or solution build) can have its own requirement, entrance criteria, functionality/capability, risk mitigations, demonstration and test requirements, and exit criteria. Also, each spiral (or increment) can expand on the capability proven at the end of the previous increment test. This may be accomplished because UML techniques (including use case, business process, class, object, sequence, collaboration, and state transition diagrams) and defined processes are followed during the builds to capture solution capability that are then integrated and tested. Thus, for example, no solution may go without passing through incremental testing (218).

An exemplary healthcare embodiment can use above-discussed spiral methodology, which at its core may be an adaptable parallel business process that can integrate and test four concurrent sub-processes described below at Initiation (210), Evaluation (212), Formulation (214) and Communication (216). The business process can govern and perform end-to-end activities of any selected medical domains (232) described above.

After generally describing each of the business process sub-processes separately and generally, a healthcare example looking at a patient care domain (232) where the user/actor (e.g., a patient) can have the option to seek diagnosis, treatment, healthcare education, referral and the like. Particularly, in the healthcare example describe below, the focus will be a patient seeking diagnosis as the primary Use Case.

Exemplary FIG. 3 generally refers to the following business sub-processes.

1. INITIATION (210), usually the first step, is directed to achieving concurrence among all stakeholders regarding the scenario's lifecycle objectives and corresponding Use Cases. In some cases, the end of the current Initiation step (210) may coincide with the start of the next iteration (212) for incorporating or augmenting knowledge and gaining confidence.

The primary activities of Initiation (210) may include, for example, first defining the scope of the scenario for capturing the context and boundary conditions, including significant requirements, functionalities, operational concepts, candidate design/solution for tradeoffs, constraints, suitable tools and processes, and acceptance criteria. This step may include identifying the actors who are involved directly in the scenario. Each actor is a UML Class, where it can be defined by Name, Responsibilities, Associations, Inheritance relationships, Composition associations, Interfaces, Vocabularies and the like known to a person having ordinary skill in the art. Also, Initiation (210) may define what each actor wants to do with the scenario. Each of these defined activities can become a Use Case.

Thus, the Initiation step (210) may conduct feasibility and tradeoff analysis for evaluating candidate design/solution alternatives against some of the scenario primary Use Cases, and mitigating risk to gain confidence. Next, for each of those Use Cases, the step/sub-process (210) may decide on the most usual course or workflow to capture its basic course and description. Once satisfied with the basic course it may then consider alternatives (if applicable) and add those as extending Use Cases. Also, Initiation (210) may review each Use Case description against the descriptions of the other Use Cases to address commonality for identifying common courses for used Use Cases.

Initiation (210) may proceed to use a Collaboration Diagram model to ensure proper identification of classes, ensure proper alignment and utilization of the enabled and integrated EAF components of this and other embodiments. Further, the sub-process may leverage lessons learned from the Knowledge Management (KM) environment (226), which may result in redefining the scope of the scenario, taking into consideration alternative analysis or reconsideration of the requirements.

Initiation (210) may also repeat the process for each actor, use Configuration Management (220) and Change Management (222) (described below) to record templates' configuration and capture changes, use a State Transition Diagram governed by relevant events, preconditions, and consequences to show the propagation of progress going from one sub-process to another toward completing the scenario at hand.

In an exemplary healthcare embodiment applied to the exemplary Diagnosis Use Case discussed above, Initiation (210) can be the first step and its main goal can be to achieve concurrence among the patient and the physician regarding the Diagnosis Use Case objectives. The primary activities can include communication with the patient to capture both subjective and objective centric information. The activities can include conducting Registration Enrollment (RE), establishing a chief complaint, establishing other complaints and updating the Electronic Patient Record Systems (EPRS).

Firstly, RE can cover a substantial range of administrative functions to support patient registration. It can have dual capabilities. One, it can import the EPRS, which provides a single interface for healthcare providers to capture, review and update a patient's medical history. Two, RE can be the focal collection point of patient centric information, which may encompass patient clinical history including demographics, allergies, active problems, current medications, recent laboratory results, skin test, immunizations, vital sign, hospitalization, patient education, employment, insurance, sex, age, marital status, occupation, number of years at occupation, location of occupation, address including zip code, race, cultural origin, height, weight, waist measurement, hip measurement, blood pressure, heart rate and the like.

Additionally, exemplary embodiments can utilize other components such as IB (208), search engine (224) and KM (226) to proactively provide potential supporting intelligence. For example, in this Diagnosis Use Case, the exemplary embodiment (when appropriately prompted) may be able to deduce sunlight available by zip code or state using planting region guides put out by the U.S. Department of Agriculture. The available sunlight can be use to predict or estimate the likelihood of a sunlight induced drug reaction or the likelihood of a vitamin D deficiency when correlated with dietary and vitamin intake.

Secondly, an exemplary healthcare embodiment can establish a chief complaint to determine the main symptom(s) that is/are bothering a patient. An exemplary healthcare embodiment can provide the patient with a list of questions such as: “Tell me about your problem?”; “What is it that is troubling you?”; or “In what way having you been feeling bad?”.

Moreover, an exemplary healthcare embodiment can initiate a database of the KM module (226) through the IB module (208) to potentially find ways to ask the patient relevant questions that are language/culture/subculture/problem specific. The database itself is initiated by the personal data gathered, for example, at RE and can begin to effectively guide the patient in addressing various subject areas such as: date of onset or approximate date of onset of symptoms; character of symptoms (e.g., drop down list of symptom characterization); mode of onset (e.g., sudden, gradual or intermittent); location of symptoms (e.g., popup picture of a body that can have gender dictated by personal information gathered); relationship of the main symptom to other symptoms, activity, bodily functions and the like; anything that exacerbates, reduces or treats the symptoms; effects of or response to any treatment; and symptom rating (e.g., on a scale of 1 to 10).

Thirdly, an exemplary healthcare embodiment can establish other complaints to determine if anything else is bothering the patient where, for example, a popup list of the most common complaints using the system's database can be displayed to a patient.

Fourthly, an exemplary healthcare embodiment applied to the exemplary Diagnosis Use Case can update the EPRS to capture and learn about any established diagnosis, established medications, the patient's relevant family medical information.

Additionally, an exemplary healthcare embodiment can prompt (query) the patient in various areas including the following areas labeled directly below as (1) through (16) and the accompanying queries and explanation thereof.

(1) Patient Medical Data

“Do you have any established diagnoses?” An affirmative answer (e.g., “yes”) can, for example, initiate a popup of common (e.g., 50 or 100 most common) Diagnoses from KM module (226) or can provide a space to type in the diagnosis which can also prompt a list of available diagnosis from KM module (226).

(2) Medications

“What are the current medications or herbals being taken?”

(3) Lifestyle Information

“Do you smoke or drink?” If affirmative. “How much?”

“Do you use any recreational drugs?” An affirmative answer can, for example, initiate a popup from KM module (226) that lists common recreational drugs by region based on home address and age.

(4) Surgical Operation History

“Have you ever had any operations?” An affirmative answer can, for example, initiate a popup from KM module (226) that lists common operations by age and sex.

(5) Allergy History

“Are you allergic to any medications or herbs?” An affirmative answer can, for example, initiate a popup from KM module (226) that lists the most common allergies by age.

(6) Family Information

“How old are your biological parents?”

““Were you adopted?”

“Do you or your parents suffer from any disease?”

“Do any diseases run in your family?” An affirmative answer can, for example, initiate a drop down of common diseases from KM module (226).

“If your parents are deceased how old were they when they died?” Approximate age can be allowed and if the answer is affirmative then the following query can be prompted from KM module (226).

“What did your parents die from?” An affirmative answer can, for example, initiate a drop down of common diseases from KM module (226).

(7) Patient Information

“How old do you feel?”, where the patient can be prompted to select “younger than your age”, “your age”, “older than your age”. If a patient selects “younger than your age”, then a patient can be prompted to respond to “How many years younger do you feel?” query from KM module (226). If a patient selects “older than your age”, then a patient can be prompted to respond to “How many years older do you feel?” query from KM module (226). Additionally, a query can be presented asking “How long have you felt this way?” from KM module (226).

“Could you do the same things that you did 5 years ago, 10 years ago, 20 years ago?” where a patient can, for example, type or select the answer.

“How is your energy level” where a patient can, for example, select “bad”, “fair”, good”, or “outstanding”.

“Do you work?” An affirmative answer can, for example, prompt a patient to respond to “What are your hours of work?” query from KM module (226).

“When do you usually go to bed for your longest rest?” where a patient can select “day” or “night”.

“What time do you go to bed?” prompting “When do you fall asleep?” query from KM module (226).

“Do you having any difficulty sleeping at night?” An affirmative answer can, for example, initiate a sleep questionnaire popup from KM module (226).

“When do you awake to begin your day?”

“Do you awake feeling rested?”

“Do you get tired towards the end of your day?” An affirmative answer can, for example, prompt a patient to respond to “Approximately when?” query from KM module (226).

(8) Neuropsychiatric History

“Have you felt anxious in the last two weeks?” An affirmative answer can, for example, initiate a Hamilton anxiety popup from KM module (226).

“Have you felt depressed in the last two weeks?” An affirmative answer can, for example, initiate Beck depression inventory popup from KM module (226).

(9) Genitourinary History

“Do you have any difficulty urinating, hard to start urinating or awaking at night to urinate?” An affirmative answer by a male can, for example, initiate BPH scale popup from KM module (226). An affirmative answer by a female can, for example, initiate an irritable bladder scale popup from KM module (226).

If male: “Do you have any difficulty with erection, poor erection and erection failure during intercourse or premature ejaculation?” An affirmative answer can, for example, initiate a sexual health questionnaire from KM module (226).

(10) Skin

“How is your skin?” where a patient can select “dry”, “normal”, “oily”.

“Do you have a rash?” An affirmative answer can, for example, prompt the user to describe the rash, scan a picture of the rash, or make a video of the rash. KM module (226) can use this information to correlate with stock libraries of dermatological lesions.

(11) Gastrointestinal

(12) Food and Diet

“Do you crave any foods?” An affirmative answer can, for example, initiate a common food cravings popup from KM module (226), which can use this information to correlate food craving with disease or deficiency states in the diagnosis effort conducted in the formulation sub-process (214).

“How many glasses of liquid do you drink every day?” Once answered, can prompt “What size glass?”

“How many ounces of soda, juice beverages, ice tea, etc. do you drink per day?” KM module (226) can use this information to calculate empty caloric or simple sugar intake per day.

Dietary history, e.g., “What have you eaten in the last week?” KM module (226) can use this information to evaluate dietary nutritional excess or malnutrition.

(13) Musculoskeletal History

(14) Travel History

(15) Other Occupations

“What are the other jobs or occupations you have held over you active life?”

(16) Additional Information

“What else would you like to tell us about yourself?”

2. EVALUATION (212) is the second step of the AIPPS system and method (200) for one exemplary embodiment where it may baseline the scenario, ensure the stability of the requirements and design, mitigate risks in order to predict the completion of the scenario, and to set up the supporting environment for tailoring relevant tools, processes, and templates. In some cases, the end of the current Evaluation step (212) may coincide with the start of the next iteration (214).

The primary activities of this step (212) may include, for example, establishing a solid understanding of the most critical requirements and functionalities that drive the scenario's planning, base design, and validation decisions.

This step (212) may also include establishing and providing a baseline detailed design iteration plan using a Sequence Diagram model by: (i) taking the Use Case description and turning it into simple outline to include the necessary steps or tasks; (ii) identifying the classes involved in the Use Case and responsible for performing identified tasks; (iii) examining each task for possible break down into a number of simpler tasks, adding in probes to examine relationships in the Use Case, and to check for and resolve critical errors that perhaps were not covered in the Use Case model; and (iv) considering whether anything discovered at this stage needs to be fed back into the Use Case model.

Further, this step (212) may include using a Collaboration Diagram model to ensure proper implementation of classes, ensure proper alignment and utilization of components of this or further embodiments, leverage lessons learned from the KM module (226) which may result in a redesign of the initial outcome, and take into consideration alternative designs or reconsideration of the requirements.

Furthermore, this step (212) may include any of the following: refining the scenario's design and selected components for initial integration and performance assessment against the primary functionalities; identifying processes, tools, and workflow automation for supporting the formulation activities; using Configuration Management (220) and Change Management (222) to record templates' configuration and capture changes; and using a State Transition Diagram governed by relevant events, preconditions, and consequences to show the propagation of progress going from one sub-process to another toward completing the scenario at hand.

In an exemplary healthcare embodiment applied to the exemplary Diagnosis Use Case discussed above, Evaluation (212) can be the second concurrent step where the main goal is to baseline the Diagnosis Use Case, verify the accuracy of the medical information gathered, analyze the patient's captured medical subjective information and mitigate risks in order to predict the diagnosis outcome.

An exemplary healthcare embodiment can refine the Diagnosis Use Case and select key questions to guide the patient in providing information for initial assessment against the primary and secondary complaints.

An exemplary healthcare embodiment can identify the workflow for supporting the Diagnosis Use Case formulation (214) activities.

An exemplary healthcare embodiment can establish an understanding of both the chief and other complaints by examining the patient's subjective information input, compare it to objective information provided by the KM module (226) and other data sources, and perform data correlation and coalescing (e.g., examining the patient with a full body computerized automated tomography (CAT) scan) to effect data verification and validation. Throughout this evaluation sub-process (212) and via the KM module (226) and testing module (218), an exemplary embodiment can correlate multiple data sources (e.g., video feed of the patient to correlate symptom description with bodily and facial responses, weight, height, body habitus with facial features with diagnostic possibilities, facial or body tics, gait, and emergency room reports of illness).

An exemplary healthcare embodiment can use the Collaboration Diagram model for assistance in identifying the Patient's class and its structure hierarchy and leverage the IB component (208), CE component (202) and KM sub-component (226) to generate specific positive and negative questions to further “flush out” the symptoms that would support the chosen diagnosis (i.e. symptoms not yet discovered, but might be present).

An exemplary healthcare embodiment can use Configuration Management (220) and Change Management (222) to record and manage changes in the EPRS.

An exemplary healthcare embodiment can use a State Transition Diagram governed by the patient's diagnosis conditions and consequences to show the propagation of progress going from one sub-process to another toward completing the Diagnosis Use Case.

An exemplary healthcare embodiment can allow for Patient Care/Diagnostic domain specific criteria for evaluation (212). It can allow for the identification of ranking, weighting of criteria and the applicable scoring values. An exemplary health care embodiment can allow for the identification of the highest weighted scored alternative solution. Risk-based-sensitivity-analysis can be utilized to compensate for error prior to reporting.

An exemplary healthcare embodiment can calculate a ranked list of diagnostic possibilities to account for the chief primary complaint and other secondary complaints.

3. FORMULATION (214) may be the third step of the AIPPS for one exemplary embodiment where it can complete the execution of the scenario based upon the best design/solution candidate. This step (214) may follow a structured workflow process, with emphasis on managing resources and controlling interactions to satisfy exit criteria, optimize relevant metrics, and ensure quality. In some cases, the end of the current Formulation step (214) may coincide with the start of the next iteration (216).

The primary activities may, for example, include: establishing and synchronizing workflow to achieve some degree of parallelism to accelerate the execution of the Formulation (216) activities; using a Collaboration Diagram model (e.g. to ensure proper alignment and utilization of any or all components of this or further embodiments and to leverage lessons learned from the KM (226) which may result in restating the decision, taking into consideration alternative formulation or reconsideration of the requirements); managing and controlling resources to ensure process optimization and avoiding unnecessary rework, then, complete the analysis, design, implementation, and testing against the defined evaluation criteria, assessing decision outcomes against the scenario's acceptance criteria to ensure adequate quality; using Configuration Management (220) and Change Management (222) to record templates' configuration and capturing changes, and using a State Transition Diagram governed by relevant events, preconditions, and consequences to show the propagation of progress going from one sub-process to another toward completing the scenario at hand.

In an exemplary healthcare embodiment applied to the exemplary Diagnosis Use Case discussed above, Formulation (214) can be the third concurrent step where the main goal is to complete the execution of the Diagnosis Use Case based upon the best diagnosis candidate.

The primary activities may, for example, include: establishing and synchronizing workflow to achieve some degree of parallelism to acceleration to organize the likely diagnosis outcome from the evaluation sub-process (212) with what should be found on physical exam or in laboratory studies listed in the KM (226); managing and controlling resources to ensure Diagnosis Use Case process optimization and avoiding unnecessary rework, complete the analysis, and testing against the defined evaluation criteria; assessing diagnosis decision outcome against acceptance criteria to ensure adequate quality; using Configuration Management (220) and Change Management (222) to record and manage the EPRS; and using a State Transition Diagram governed by patient condition and consequences to show the propagation of progress going into the communication sub-process (216) toward completing the Diagnosis Use Case at hand.

4. COMMUNICATION (216) may be the fourth step/sub-process of the AIPPS (200) for one exemplary embodiment where it can ensure that a finalized decision and supporting/associated materials are generated and ready for delivery to relevant users; and for getting users' feedback.

The primary activities of this step (216) may, for example, include: utilizing a range of computer and communication technologies, such as instant messaging, e-mail, chat room, discussion databases, mobile communicators, shared white board, and streaming media including audio, video or web conferences; coordinating and collaborating via web and between various users spread across multiple domains, sites and time zones to accomplish a shared task and to reach a decision(s); using Configuration Management (220) and Change Management (222) to record templates' configuration and capture change; and using a State Transition Diagram governed by relevant events, preconditions, and consequences to show if there is a need to transition to a prior sub-process (214, 212 or 210) to ensure the completeness and accuracy prior to final result reporting of the scenario at hand.

By the end of this communication step (216) all of the scenarios' objectives may have been met and the scenario should be in a position to be closed out. In some cases, the end of the current scenario may coincide with the start of another, leading to the next iteration (e.g., 210).

In an exemplary healthcare embodiment applied to the exemplary Diagnosis Use Case discussed above, Communication (216) can be the fourth concurrent step where the main goal is to ensure that a finalized diagnosis decision and supporting/associated materials are generated, recorded in the EPRS and ready for delivery to a patient.

Here, for example, the communication module (216) can be informed by the initiation module (210) and the Diagnosis Use Case that a patient may be without a physician scenario. Thus, the communication sub-process (216) can be prepared to print and communicate (e.g., via a range of computer and communication systems, such as instant messaging, e-mail and chart room) a report of the likely diagnostic possibilities and the need to see a physician for examination and further testing.

Additionally, the communication module (216) via the KM (226) might also list convenient treatment facilities based on the personal data collected. By the end of this communication step (216) all patient care diagnosis objectives may have been met and the Diagnosis Use Case should be in a position to close out. In some cases, the end of the current scenario may coincide with the start of another leading to a next iteration (e.g., 210). For example, the Diagnosis Use Case can require entry into the Diagnostic Services Domain, for example, Specialty MD Domain, Hospital Domain or Financial Domain and the like.

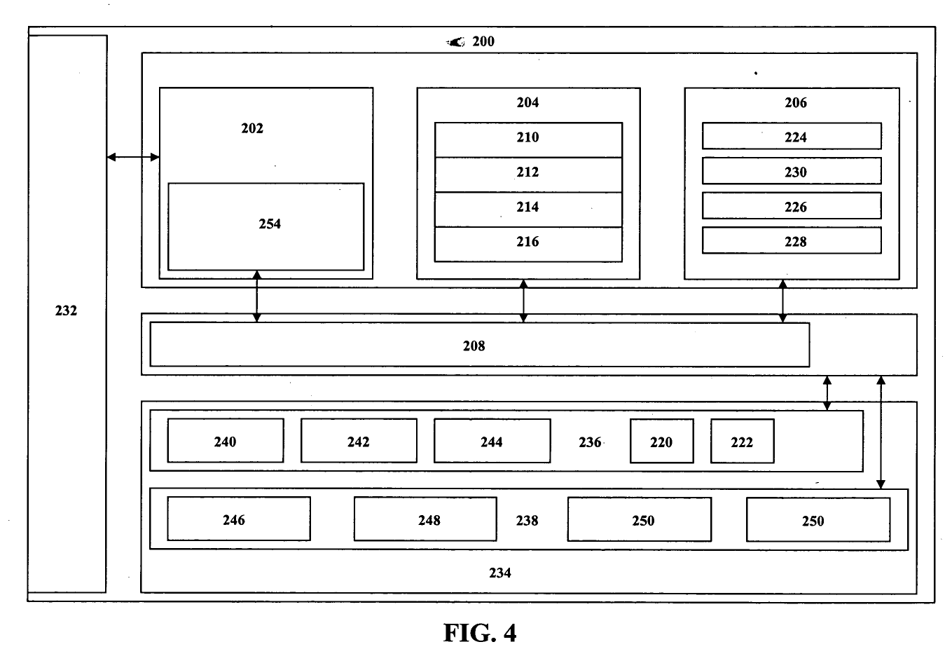

Referring to FIGS. 3-4, in an exemplary embodiment, an AIPPS enabled and integrated EAF system and method (200) maintains a Configuration Management (CM) component (220). The CM component (220) may cover problem-domain development artifacts, scenarios, requirements, test cases, and documentation. A CM process (220) according to this embodiment may use an activity based approach, associating the changes to configuration items. Activity based change management is considered to be a way to simplify and improve change capability. It may manage the integration that the entire tool set requires for Use Case development, and can track individual changes to software assets and documents throughout the lifecycle. It also may streamline and simplify the scenario development process, enabling problem domain specialists to construct scenarios quickly and more efficiently.

Referring to FIGS. 34, in an exemplary embodiment, an AIPPS enabled and integrated EAF system and method (200) may implement a change management process/component (222) that is intended to control all the unforeseen changes that may arise during the course of scenario development. This process/component (222) manages the effects that could otherwise jeopardize procedures and performance, affect scope, solution definition, deliverable definition, and the quality of the final result.

The change management procedure (224) can be launched when a need for a change arises. The end result of the procedure may be that “the change is implemented”, “the change is deferred”, or “the change is rejected”.

Referring to FIGS. 2-4, in an exemplary environment, an AIPPS enabled and integrated EAF system and method (200) may have a Collaborative Environment (CE) component (202) to allow participants to communicate, coordinate and collaborate. The CE (202), and the present embodiment overall, may apply Web Browser Intelligence (WBI) to keep track of a user's Internet activity which may simplify Web browsing for the user.

For example, in at least one healthcare embodiment, the CE (202) can provide a GUI (e.g., windows-based) to establish communication between the actor (user, e.g., patient) workstation and one or more servers. CE (202) can utilize a wide range of computer and communication technologies.

Referring to FIGS. 2-4, in an exemplary embodiment, an AIPPS enabled and integrated EAF system and method (200) may apply an Intelligent Broker (IB) component/module (208) that may be used to build a substantially flexible, extensible and secure architectural framework; to manage real time events between clients, servers, and mobile devices providing a highly scalable, event driven model to integrate applications and people regardless of device or location. Further, an IB (208) may improve framework flexibility and adaptability using powerful middleware for heterogeneous application connectivity and integrity, message distribution, message routing and transformation. An IB (208) may support database integration for message logging, merge, and update. An IB (208) may also provide an affordable distributed integration platform ideal for distribution across the enterprise with the capability to add custom extensions into the plug-ins framework. Additionally, an IB (208) may use multiple transports supporting HTTP tunneling and quality of protection enabling enterprises to confidently and securely communicate across the Internet.

Knowledge Enablement and Augmentation Environment

Referring to FIGS. 24, in an exemplary embodiment, an AIPPS-enabled and integrated EAF system and method (200) may include a Knowledge Enablement and Augmentation (KEA) environment component (206) that may further comprise a Search Engine component (224), a Knowledge Management (KM) component (226) and a Digital Media Solution (DMS) component (228).

(1) Search Engine

The search engine (224) may be a full text search engine written in Java (or any other language known to one having ordinary skill in the art). The use of Java and Internet protocols, for example, may allow easy integration and communication with cross platform applications. It also may enable users to incorporate new document types and to easily customize new user interfaces. The KEA (206) may use metadata (230) (the tags that are associated with documents such as author names, descriptions, and keywords) to enhance the search. Search features may include free text query specification, advanced query operators, multi lingual support, summarization, search results clustering, and index compression.

(2) Knowledge Management

This KM subcomponent (226) may provide technologies and processes enabling user communities to exchange and optimize knowledge and experiences to help them reach an optimal decision. A KM component (226) may include these additional subcomponents:
(1) Expertise—the specialized knowledge, skill or ability which is embodied in an individual (tacit knowledge);
(2) Content—explicit knowledge, information and data which is represented in artifacts;
(3) Collaboration—the activity of working with others, especially in a joint intellectual effort;
(4) Self-service tools, applications and knowledge repositories that help link user communities to their work; and
(5) Learning—the activity of getting knowledge or understanding facts, ideas, or how to do things.

In an exemplary healthcare embodiment, Expertise can include a database of symptoms (where a symptom or group of symptoms can be linked to a diagnosis and treatment), a database of inquiries (e.g., “Tell me what your problem is?”, “What is troubling you?”, “In what way have you not been feeling well?”, etc.), a database of diagnoses (e.g., with a sub-database of traditional medical knowledge such as traditional Chinese medicine (TCM) diagnoses or ayurvedic diagnoses), a database of treatments (which can be divided by types of treatments such as allopathic conventionally western medical treatments, western herbal treatments, TCM treatments and ayurvedic treatments) and a database of side effects. Moreover, for example, in a database of diagnoses, a diagnosis can be linked to a treatment or a ranked group of treatments. Also, for example, in a database of treatments, a treatment can be linked to a side effect, a single drug, a group of drugs and/or to a protocol. Further, these databases can be language, culture and subculture specific.

In an exemplary healthcare embodiment, Content can include explicit knowledge, information and data, which represents a collection of health data repository containing operational clinical information, derived from various sources, and residing on numerous platforms. Additionally, an exemplary healthcare embodiment can: provide patient clinical information; support on-demand delivery of patient care regardless of the physical location; and provide access to high quality and secured information for supporting research and clinical analyses. Moreover, an exemplary healthcare embodiment can enable clinical information to be reported, updated, transmitted, retrieved and analyzed. It can provide a basis for a common lexicon (language of terms) for improved communication. It can also: organize data into defined categories; allow for the entry of descriptive data and actions taken on certain defined incidents; provide on-line status and support for various requests; and compile various reports and the like known to one having ordinary skill in the art.

Generally, a KM subcomponent (226) may include numerous other subcomponents such as an on-line database/content management system, shared work spaces, document management systems, virtual conferencing capabilities, computer-based training, and helpdesk system. The KM subcomponent (226) may capture, create, disseminate, and leverage knowledge for the purpose of increasing overall performance. The KM subcomponent (226) may also facilitate embodiments of the AIPPS-enabled EAF system and method (200) in accessing and mining structured information stored in data warehouses and unstructured information stored in documents accessible across the Internet. In further embodiments, a KM subcomponent (226) may have security features defined by user roles and organization. The application of a KM subcomponent (226) may enable clients to create new knowledge (refine/validate), increase learning across user communities, disseminate knowledge (multicast), and act more effectively (improved decision-making).

(3) Digital Media

In an embodiment of the AIPPS-enabled and integrated EAF system and method (200), a Digital Media Solution (DMS) subcomponent (228) may be incorporated. The technology associated with this subcomponent (228) can help user communities to leverage digital media in various steps of its process. The DMS subcomponent (228) may be an open, standards-based framework component that integrates hardware and/or software and may enable flexible, low costs solutions that will be able to evolve as new technologies emerge. In further embodiments, a DMS subcomponent (228) may include capabilities such as:
(1) Digital Content Creation capability which provides state-of-the art 3D animation, and content editing;
(2) Digital Content Management capability which provides an end-to-end solution for management, archiving and retrieval of content for clients who require support for scenario execution;
(3) Digital Media Commerce capability which enables clients to search, view, manage, collaborate, purchase, sell and download digital assets directly through the Internet;
(4) Secure Content Distribution capability which delivers a comprehensive solution for digital content distribution and rights management that can be applied to various types of content—including audio, video, text and image;
(5) Broadcast Content Distribution capability which distributes digital content including audio, video, text and image over IP multicast networks, and provides basic desktop editorial and review processing;
(6) Audio Asset Management capability which provides a high-end audio broadcasting solution with the ability to automate the broadcast of digital content over multiple channels in a cost-effective way;
(7) Broadcast Asset Management capability which provides a comprehensive infrastructure tool set to leverage IT technologies for optimal resource utilization and performance; and
(8) Digital media infrastructure and consolidation capability to optimize the scalability of the storage system, support heterogeneous broadcast operations, and to help transform broadcasting from analog to digital.

Component Service-Based Architecture

In at least one exemplary embodiment, an AIPPS-enabled and integrated EAF system and method (200) may follow the implementation of a component service-based architecture as particularly shown in FIG. 4. This can provide the ability for components to advertise the services that they may perform so that the EAF system and method (200) may add and remove services as needed. These services may correspond to Business Services.

Vertically, from the left side, FIG. 4 shows: Community Multi Domain Business Services (232) (e.g., doctor domains, patient domains, pharmacy domains, laboratory domains, image processing domains, business office domains and the like) which may be the processes that create value for the user community and are determined by the particular problem domain. From the top, we have Community Application Services (200), which may provide the application frameworks to execute selected enabled and integrated EAF's community domain Business Service (232). The application services may include Interaction (202) having web-based collaboration (254) (e.g., wireless), Multi-Processes (204), Information Management (206), and Intelligent Broker/Common IT Services (208). These services may provide a common, repeatable method for accessing, creating pools of commonly used infrastructure resources, processing, managing, and disseminating finalized decision's information. Applications communicate with each other and interact with the infrastructure via the Intelligent Broker (IB) module/component services (208).

From the bottom, the Infrastructure Services component (234) may provide pools of processing and networking resources for applications. The exemplary enabled and integrated EAF system and method (200) of FIG. 4 drives down to the Service Level Management component (236), which may automate the provisioning of the servers in case of failures and can include, for example, problem management service (240), security services (242), workload services (244) and the like known to one having ordinary skill in the art. Underlying all these capabilities is a set of Resource Virtualization Services Management (238) which may simplify the infrastructure; reduce management complexity; increase resource utilization; reduce cost; improve the effectiveness of IT as it treats resources of individual servers, storage, and networking products to function as a single pool or entity, allowing access and management of resources across an organization more efficiently, by effect and need rather than physical location. For example, Resource Virtualization Services Management (238) can include, for example, multi-domain servers (246), multi-domain storage (248), eco-system network (250), resource mapping (252) and the like known to one having ordinary skill in the art.

Semantic Modeling

Additionally, referring again to FIGS. 24 generally, at least one embodiment of the present invention including a CE component (202), a MPE component (204) and a KEA component (206) (that are substantially operatively networked via an IB component/module (208)) can enable semantic modeling and the resulting domain-specific taxonomy and ontology. The spiral modeling methodology of an exemplary business process described above can permit dynamic scalable growth of the taxonomy and ontology embodied in the semantic model. When applied to a domain (232), the spiral modeling methodology can assemble, on demand, the taxonomy and ontology of the domain (232) so as to abstract and accommodate the modeling of relevant enterprise applications.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above described embodiments should be regarded as illustrative rather than restrictive. Accordingly, it should be appreciated that variations to those embodiments can be made by those skilled in the art without departing from the scope of the invention as defined by the following claims.

What is claimed is:

1. A healthcare-related architectural framework, comprising:
a network;
one or more healthcare-related domains on the network;
a collaborative environment component on the network, the collaborative environment component having a graphical user interface;
a methodology and process environment component on the network, the methodology and process environment component having a business process embodied in a computer readable media, the business process applied to the one or more healthcare-related domains;
a knowledge enablement and augmentation environment component on the network; and
an intelligent broker component on the network, the intelligent broker component operatively interconnecting the environmental components of the architectural framework.

2. The architectural framework of claim 1 wherein the business process models the one or more healthcare-related domains using a spiral methodology, the business process having an initiation sub-process, an evaluation sub-process, a formulation sub-process, and a communication sub-process.

3. The architectural framework of claim 2 wherein two or more of the sub-processes of the business process run substantially parallel.

4. The architectural framework of claim 1 further comprising:
a configuration management component on the network, the configuration management component operatively connected to the components of the architectural framework;
entry criteria stored in the configuration management component;
rules stored in the configuration management component;
exit criteria stored in the configuration management component;
the business process applied to a first healthcare-related domain; and
the business process applied to a second healthcare-related domain,
whereby the components of the architectural framework are initiated according to the entry criteria, run according to the rules and completed according to the exit criteria, thereby providing navigation functionality between the first healthcare-related domain and the second healthcare-related domain.

5. The architectural framework of claim 1 further comprising:
a change management component on the network, the change management component operatively connected to the components of the architectural framework.

6. The architectural framework of claim 1 wherein said knowledge enablement and augmentation environment component has a search engine, a knowledge management subcomponent and a digital media subcomponent.

7. The architectural framework of claim 1 wherein the one or more healthcare-related domains are one or more of a patient domain, a family domain, a business office domain, a research domain, a quality and performance domain, a patient safety domain, a finance domain, a policy and planning domain, a technical support domain and a compliance domain.

8. The architectural framework of claim 7 having one or more patient domains wherein the one or more patient domains are one or more of a primary care doctor domain, a specialist care doctor domain, a community hospital domain, a referral hospital domain, a university hospital domain, a nursing home domain, a care coordination domain, a diagnostic services laboratory domain, a diagnostic services imaging domain, a preventative care domain, a nursing professional domain, a paraprofessional domain, a pharmacy domain, a rehabilitation domain, a strategic planning and measurement domain, a dentistry domain and an ethics domain.

9. A method of modeling a use case by applying a spiral methodology to one or more domains, comprising:
providing one or more domains on a network accessible to a plurality of client computational devices;
storing a business process on the network, the business process embodied on a computer readable media, wherein the business process has a spiral methodology configured to be applied to the one or more domains on the network;
initiating concept capturing for a use case by querying an actor operating a client computational device;
evaluating data submitted by the actor in response to one or more queries;
establishing a baseline plan based on the evaluated data;
formulating a solution for the use case in accordance with the baseline plan;
generating data associated with the solution for the use case, the associated data being for one or more stakeholders, wherein the one or more stakeholders are defined by one or more roles;
communicating the data to one or more client computational devices, wherein a subset of the data is accessible to each of the one or more stakeholders according to each of the one or more roles of each stakeholder; and
closing out the use case.

10. The method of claim 9 further comprising:
performing feedback looping between the steps of initiating, evaluating, formulating and communicating.

11. The method of claim 9 further comprising:
performing the steps of initiating, evaluating, formulating and communicating substantially in parallel.

12. The method of claim 9 further comprising:
supplementing concept capturing with computational intelligence, wherein the step of evaluating data submitted by the actor further includes evaluating data from computational intelligence.

13. The method of claim 9 wherein the one or more domains are one or more healthcare-related domains.

14. The method of claim 13 wherein the actor is a patient or person acting on behalf of a patient.

15. The method of claim 14 wherein the step of initiating concept capture further comprises:
establishing a one or more complaints responsive to symptoms entered by a patient.

16. The method of claim 15 wherein the step of evaluating data submitted by the actor further comprises:
calculating a list of diagnostic possibilities for each of the one or more complaints.

17. The method of claim 16 wherein the solution for the use case is a diagnosis.

18. The method of claim 14 further comprising:
using a configuration management component and a change management component to record and manage change in a electronic patient record.

19. The method of claim 14 further comprising:
using a state transition diagram governed by the use case to track progress from any of the steps of initiating, evaluating, formulating and communicating towards closing out the use case.

20. The method of claim 9 wherein the business process is a semantic business process, the semantic business process embodied on a computer readable media, wherein the semantic business process has a spiral methodology configured to be applied to the one or more domains on the network.

21. An architectural framework, comprising:
a network;
one or more domains on the network;
a collaborative environment component on the network, the collaborative environment component having a graphical user interface;
a methodology and process environment component on the network, the methodology and process environment component having a business process embodied in a computer readable media, the business process applied to the one or more domains;
a knowledge enablement and augmentation environment component on the network; and
an intelligent broker component on the network, the intelligent broker component operatively interconnecting the environmental components of the architectural framework.

22. The architectural framework of claim 21 wherein the business process performs semantic modeling of the one or more domains using a spiral methodology, the business process having an initiation sub-process, an evaluation sub-process, a formulation sub-process, and a communication sub-process.

23. The architectural framework of claim 22 wherein the methodology and process environment component and the knowledge enablement and augmentation environment component are both semantic in nature.

24. The architectural framework of claim 22 wherein the components on the network support and develop semantic architecture and semantic environments.
